(19) United States
(12) Patent Application Publication
(10) Pub. No.: US 2005/0087084 A1
(43) Pub. Date: Apr. 28, 2005

(54) Squeegee handle assembly

(76) Inventor: David Gray, St. Paul, MN (US)

Correspondence Address: Anthony G. Eggink;Eggink & Eggink, 3100 First National Bank Building, 332 Minnesota Street, St. Paul, MN, 55101, US

(21) Appl. No.: 10/861,974

(22) Filed: Jun. 4, 2004

Related U.S. Application Data
(60) Provisional application No. 60/515,308, filed on Oct. 28, 2003.

(51) Int. Cl. B41F 15/44

(52) U.S. Cl. 101/123; 15/245

(57) ABSTRACT

A squeegee handle assembly for holding a squeegee applicator. The handle assembly has a tubular body, an externally lipped opening and a stabilizing structure. The stabilizing structure is disposed on the inner wall of the tubular body opposite the externally lipped opening. A pair of end caps are provided to engage the ends of the tubular handle body. The handle assembly is constructed and arranged to trap a portion of the squeegee applicator within the tubular body without impairing the function of the exposed squeegee applicator blade during use.

### BACKGROUND OF THE INVENTION

This application claims the benefit of U.S. Provisional Patent Application No. 60/515,308, filed on Oct. 28, 2003.

This invention relates generally to a squeegee handle assembly. More particularly, this invention relates to a squeegee handle assembly for holding a squeegee applicator having opposing blade members and a central portion having spaced parallel stabilizing ribs.

Squeegee applicators are known and have been used in the graphic, sign, tape, film, adhesive, silk screen and pressure sensitive adhesive industries for many years. These applicator tools may be used as applicators, squeegees and spreader tools and are provided in various configurations, i.e., square or round corners, in various sizes, i.e., 4, 6 and 12 inches in length, and constructed of various materials, i.e., polyethylene, nylon, teflon, PVC, rubber or poly blends. Importantly, these squeegee and applicator tools have specific durability, glide, memory and flexibility requirements and standards.

Although squeegee application tools are provided in the marketplace in many sizes, structures and configurations, most are formed to have opposing tapered blade structures separated by a pair of centrally disposed parallel stabilizing ribs which are protrusions or ridges formed on the central portion of the squeegee body and which are grasped by the user's hand during use.

Squeegee application tools are typically utilized by direct hand manipulation which allows the user to feel and control the movement and deformation of the pliable squeegee bodies via directed forces. The use of various tool handles have been proposed and used in the marketplace, however, the utilization of these applicator tool handles effect the user's feel, control and performance of the squeegee applicators. For example, in U.S. Pat. No. 5,865,945 to McConaughy a pressure sensitive film applicator tool handle is disclosed having a generally elliptical handle body having a slot and an internal gripping arrangement that grips the central portion of the applicator tool between the spaced protrusions. The gripping arrangement of this handle body limits the flexibility of the squeegee applicator and particularly the control of the blade of the applicator being utilized. U.S. Pat. No. 6,453,970 to Stone et al. discloses an applicator tool for applying decals to surfaces of automobiles wherein a tubular member is provided having a slot which engages the applicator tool in the valley between the spaced apart protrusions to provide angular movement of the applicator blade. Although these prior art tool handles may allow specific uses of the squeegee applicator, the handle structures hinder and limit the user's feel, performance and use of the squeegee for many other applications. Particularly, the torsional movement of the squeegee applicator blades is impaired by the utilization of these prior art handle members. Therefore, a need exists in the marketplace to provide a squeegee handle which allows a user to utilize a squeegee applicator blade without impeding or limiting the user's feel and function of the squeegee applicator body itself.

### SUMMARY OF THE INVENTION

The squeegee handle assembly of the present invention comprises a tubular structure with squeegee holding means which minimize the impairment of the feel, function and performance of the squeegee applicator body. The handle assembly is comprised of a tubular body having a formed elongated opening and a cooperating blade stabilizing structure within the tubular body. The tubular structure has an externally lipped opening to engage the squeegee applicator over the first rib or protrusion of the squeegee body. The externally lipped opening of the tubular handle structure provides outwardly protruding lips which are configured to extend between the parallel ribs of the squeegee applicator and which permit the squeegee blade to flex and roll or pivot during use. Preferably the opposing lips diverge outwardly to permit the tapered blades of the squeegee applicator to flex and roll or pivot during use.

The tubular handle structure has a predetermined diameter to secure one blade of the squeegee applicator between the first protrusion and the interior wall of the tubular handle structure. The tubular structure also permits the interior blade to flex and roll or pivot during use. The tubular handle structure further has a stabilizing structure, such as stabilizing fins, disposed along its interior periphery opposite the lipped opening to receive the tip of the interior squeegee blade. The stabilizing fins are preferably in a divergent relationship to receive the tapered blade end of the squeegee and to permit the squeegee body to flex during use. A pair of end caps are further provided to maintain the squeegee body therebetween and which maintains the blade disposed on the interior of the handle in a clean condition and/or to maintain a used blade away from contact with a user's hand.

It is an advantage of the present invention to provide a functional handle assembly for use with a squeegee applicator body. The handle assembly provides two spacially aligned holding structures for specified portions of a squeegee applicator body. Specifically, a divergent fin structure is provided on the interior wall of the tubular handle body to engage the tip of the blade held within the handle body. In cooperation, a diverging external lip structure is provided to engage the stabilizing rib of the applicator body. These cooperating holding structures permit the squeegee applicator to flex and twist during use to thereby maximize the function of the squeegee when used with a handle assembly.

In use, one of the tapered blades of the squeegee is laterally slid into the handle structure whereby the squeegee body is held or trapped between the divergent lipped opening and the divergent stabilizing fins. The opposing external lips of the handle structure are curved outwardly to allow easy insertion of the squeegee into the handle and to permit the squeegee body to flex and roll or pivot at the blade sections and the midsection during use. The end caps maintain the squeegee body within the handle structure and keep the trapped blade in a clean condition disposed in the interior of the tubular handle. Subsequently, the used blade may be housed within the handle structure to thereby prevent undesirable substances to contact the user's hand.

These and other benefits of this invention will become apparent from the following description by reference to the drawings.

### DRAWINGS OF THE INVENTION

FIG. 1 is a top plan view of a squeegee applicator used with the handle assembly of the present invention;

FIG. 2 is an end view thereof;

FIG. 3 is an end plan view of the squeegee handle assembly of the present invention and showing a squeegee applicator held therein;

FIG. 4 is a top plan view of the squeegee handle assembly holding a squeegee applicator;

FIG. 5 is a lateral view showing an end cap for use in the handle assembly;

FIG. 6 is a frontal perspective view of the squeegee handle assembly of the invention;

FIG. 7 is a sectional view of the handle assembly body; and

FIG. 8 is a top view showing a squeegee applicator held in the handle assembly of the invention.

### DESCRIPTION OF THE PREFERRED EMBODIMENTS

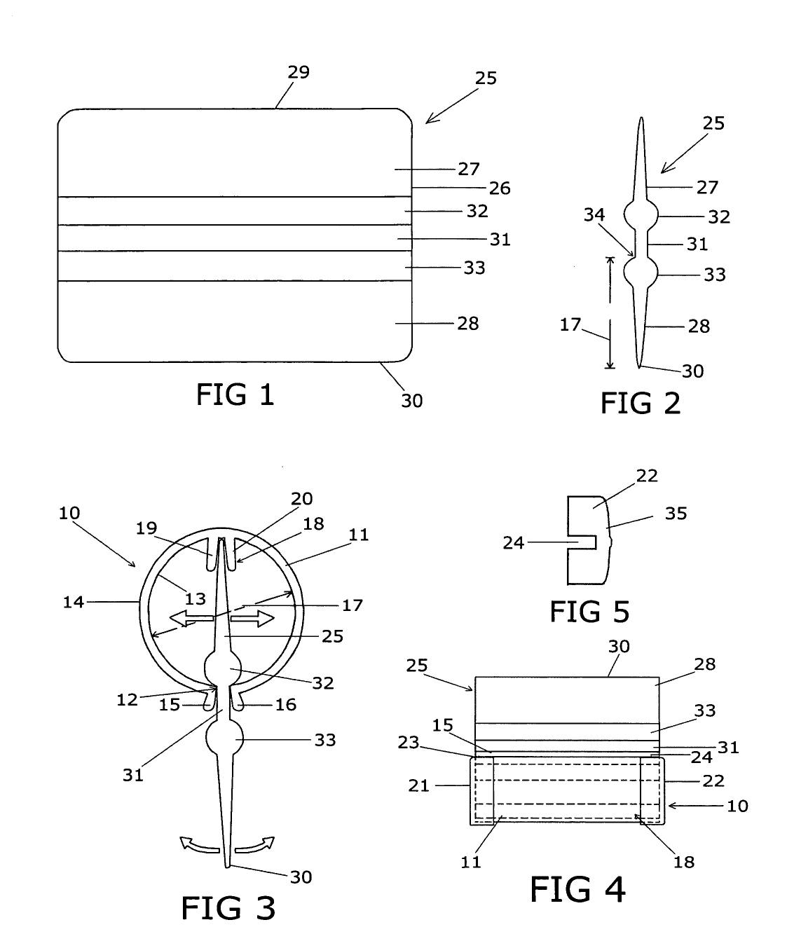

Referring to the drawings, the present invention relates to a squeegee handle assembly 10. The squeegee handle assembly is constructed and arranged to engage and hold a squeegee applicator 25, which is shown in FIGS. 1 and 2. The squeegee applicator 25 is typically formed of a polymeric material, i.e., polyethylene, nylon, teflon, PVC, rubber, poly blends or the like, and has a body 26 having opposing blade portions 27 and 28, each having an edge 29 and 30, respectively. The blade portions 27 and 28 are shown to have a tapered cross-sectional configuration as particularly shown in FIG. 2. The squeegee body 26 has a midsection 31 defined by a pair of ribs 32 and 33 which extend parallel to each other across the body 26. In use, the squeegee applicator 25 is typically grasped in the hand whereby one blade is held and the opposite blade is utilized for spreading ink or other material, for example, or directing a vinyl film against an object.

As the edge of the blade becomes worn, the user may switch use to the opposite blade. The force of the blade edge against the hand and/or a soiled blade may cause a user to desire utilizing a handle. However, it is important that the handle does not impair the function and performance of the squeegee applicator. For example, the flexing and torsional movement of the squeegee body 26 is important in the utilization of the applicator.

Referring to FIGS. 3-5, the squeegee handle assembly 10 of the present invention is shown comprised of a tubular body structure 11 having an opening 12 to engage the squeegee applicator 25 over the first rib of the squeegee body 26 as indicated by numeral 34 of FIG. 2. The tubular handle body structure 12 further has protruding lips 15 and 16 which extend between the parallel ribs 32 and 33 of the squeegee applicator 25 and which permit the outwardly extending squeegee blade to flex and roll or pivot during use as indicated by the arrows in FIG. 3. The protruding lips 15 and 16 are shown to have ends that extend outwardly, or divergent with respect to each other, to thereby provide easy access of the applicator tool 25 within the handle assembly body structure 11.

The tubular handle body structure 11 has a predetermined inside diameter 17 to secure one blade of the squeegee 25 between the first rib 32 and the interior wall 13 of the tubular handle structure 11. The tubular handle structure 11 further has stabilizing member 18 shown comprised of stabilizing fins 19 and 20 disposed along its interior periphery opposite the opening 12 to receive the tip of the interior squeegee blade. The stabilizing fins 19 and 20 are shown extending from the interior wall 13 in a V-shaped or divergent configuration to thereby receive the tapered end of the squeegee blade. This arrangement permits the interior blade of the squeegee body to flex and roll within the handle body structure during use.

The tubular body 11 may be formed of a semi-rigid polymeric or plastic material via extrusion for example. The polymeric material may be polyethylene, PVC, ABS, poly blends, styrenes or like materials. The squeegee holding means are unitary with the body and formed during the extrusion process, for example.

A pair of end caps 21 and 22 are provided which maintain the squeegee body 26 therebetween and which maintain the blade disposed on the interior of the handle body 11 in a clean condition. As shown in FIG. 5, the end cap 22 has a slot 24 which receives and engages the outside surface of the lips 15 and 16 of the tubular body 11 and which abuts the edge of the body 26 of the squeegee applicator 25. The end caps 21 and 22 with slots 23 and 24 respectively, are preferably formed of a polymeric material, i.e., a flexible rubber or plastic material, and which frictionally fit over the ends of the tubular body 11 of the handle assembly 10. As shown, the end cap body may have a rounded or protruding outer surface 35 which aids in providing a soft handle assembly conducive with the environment in which the applicator is typically used, i.e., in the vinyl, film, sign and graphic industries.

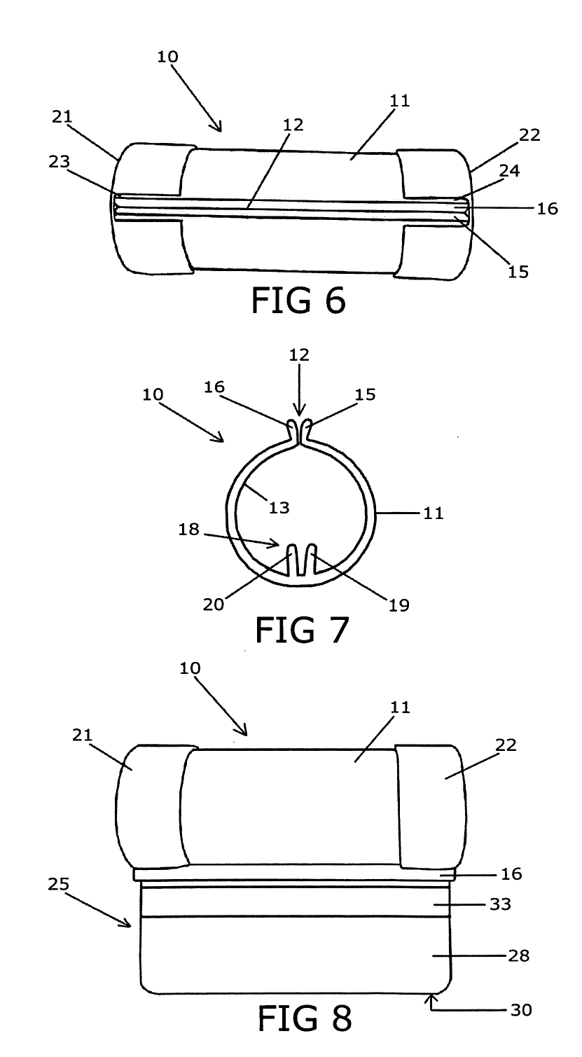

Referring to FIGS. 6 and 7, the squeegee handle assembly 10 is shown to have tubular body 11 with externally protruding lips 15 and 16 which define elongated opening 12 that extends linearly along the tubular body 11. The stabilizing member 18 is shown comprised of fin members 19 and 20 which extend from inner surface 13 of the tubular body 11. The fin members 19 and 20 are in a divergent relationship when viewed in cross-section (FIG. 7) and extend generally opposite and spacially parallel the externally disposed lips 15 and 16. As shown in FIG. 3, the divergent stabilizing fins 19 and 20 are adapted to trap the tip of either blade 27 or 28 of the squeegee applicator 25.

As further shown, end caps 21 and 22 are shown positioned over the ends of the tubular body 11. Slots 23 and 24 in the end caps 21 and 23 are shown to receive the external lips 15 and 16 of the tubular body 11. The slots 23 and 24 have a width which permit the lips 15 and 16 to be in a spread apart configuration and holding the squeegee applicator 25. The end caps may be constructed of a semi-rigid or flexible polymeric or rubber material. The soft flexible material provides a handle assembly which is safe and worksite compatible. The end cap material composition may be smooth on the interior to provide a frictional hold with a smooth outer surface 14 of the tubular body 11, i.e., a smooth polymeric surface formed by injection molding or formed via extrusion. The exterior of the end cap may be a textured surface to enhance gripping.

During use, the operating blade will flex and twist depending upon the surface on which it is used. The torsional movement of the operating blade has an opposite effect on the blade captured in the handle assembly. The structure and composition of the externally lipped opening and stabilizing member of the handle assembly allow the captured blade to engage in the natural opposite movement to thereby compliment the function of the operating blade.

In use, one of the blades of the squeegee 25 is slid into the handle structure 10 between the divergent lips 15 and 16 of opening 12 and the divergent stabilizing fins 19 and 20. The opposing lips 15 and 16 of the handle structure 11 are curved outwardly to allow easy insertion of the squeegee 25 into the handle body 11 and to permit the squeegee 25 to flex and roll or pivot at the midsection 31 during use. The end caps 21 and 22 maintain the squeegee body 26 within the handle structure 11 and keep the trapped blade in a clean condition disposed in the interior of the tubular handle body 11. The handle assembly 10 provides a user with a comfortable ergonomic hand grip which permits the applicator tool to function as intended.

As discussed, squeegee applicators may be provided in any length, i.e., approximately 4, 6 and 12 inches (approximately 10.2, 15.2 and 30.5 cm, respectively) and the length of the tubular handle body is approximately the same length as that of the squeegee applicator with which it is used. The dimensions, other than the length, for the squeegee applicators as well as those of the tubular handle bodies are generally the same. For example, a squeegee applicator 25 having a length of approximately four inches (10.2 cm), an overall width of approximately 3.0 inches (7.6 cm), a blade width of approximately 1 inch (2.5 cm), stabilizing ribs with a diameter of approximately 0.31 inches (8 mm), a central portion having a width of approximately 0.31 inches (8 mm) and having a central portion thickness of approximately 0.13 inches (3 mm) and blades which taper from approximately 0.16 inches (4 mm) to approximately 0.03 inches (1 mm) may utilize a squeegee handle assembly 10 having dimensions as follows: a tubular body length of approximately 4 inches (10.2 cm), an inner diameter of approximately 1.25 inches (3.2 cm), a wall thickness of approximately 0.08 inches (2 mm), divergent lips each extending outward from the tubular body approximately 0.2 inches (5 mm), stabilizing fins each extending outward from the interior of the tubular body approximately 0.31 inches (8 mm). The stabilizing fins may be spaced apart approximately 0.06 inches (1.5 mm) at the base and approximately 0.125 inches (3 mm) at the top. The stabilizing fins extend into the tubular body approximately 25% of the body inner diameter. The end caps may have a diameter of approximately 1.31 inches (3.3 cm), a length of approximately 0.88 inches (2 cm) with a slot length of approximate 0.7 inches (1.8 cm) and width of approximately 0.38 inches (1 cm). The above dimensions are exemplary and other dimensions for the handle assemblies and associated squeegee applicators may be utilized according to the teachings and within the purview of the present invention.

As many changes are possible to the squeegee handle assembly embodiments of this invention, utilizing the teachings thereof, the description above and the accompanying drawings should be interpreted in the illustrative and not the limited sense.

1. A squeegee handle assembly for a squeegee applicator body structure having a central portion with spaced parallel stabilizing ribs, opposing blade members each having an edge and having a specified distance between each blade edge and the inner edge of the first stabilizing rib, said squeegee handle assembly comprising:
a) a tubular structure having an inner wall and an elongated slot opening and an inner diameter approximately the specified distance between the blade edge and the inner edge of the first stabilizing rib of the squeegee applicator body structure;
b) divergent fin members extending from said inner wall of said tubular structure and being positioned on said inner wall opposite and generally aligned with said elongated slot opening; and
c) opposing external lip members formed on said tubular structure at said elongated slot opening, said opposing lip members diverging outwardly with respect to each other, whereby the utilization of the squeegee handle assembly with a squeegee applicator with the securement of one blade edge positioned in said divergent fin members and the opposing lip members positioned over the first stabilizing rib permit the squeegee applicator to be controlled by a user so that the applicator blades are able to flex and roll or pivot during use.

2. The squeegee handle assembly of claim 1, wherein end caps are provided to cover the ends of said tubular structure, said end caps each having a slot to receive said opposing lip members and the central portion of the squeegee applicator body.

3. The squeegee handle assembly of claim 2, wherein said tubular structure and said end caps are formed of a polymeric composition.

4. The squeegee handle assembly of claim 1, wherein said divergent fin members are spaced apart at the base of divergence at said inner wall.

5. The squeegee handle assembly of claim 1, wherein said tubular structure has a length which is approximately the length of the squeegee applicator body.

6. A squeegee handle assembly comprising:
a) a tubular structure having squeegee applicator holding means for engaging a squeegee applicator body structure having opposing blade members and a central portion with spaced parallel stabilizing ribs;
b) said squeegee holding means of said tubular structure comprising an externally lipped opening to engage the squeegee applicator body over the first rib; and
c) said squeegee holding means further comprising a stabilizing structure to functionally cooperate with said externally lipped opening, said stabilizing structure being disposed on the interior of said tubular structure and positioned opposite said externally lipped opening, said stabilizing structure being constructed and arranged to receive a blade member end portion.

7. The squeegee handle assembly of claim 6, wherein said tubular structure has a predetermined interior diameter and wherein said externally lipped opening comprises opposing lips which diverge outwardly with respect to each other.

8. The squeegee handle assembly of claim 6, further having a pair of end caps having a diameter for positioning over the ends of said tubular structure, each said end cap having a slot therein for receiving said externally lipped opening.

9. The squeegee handle assembly of claim 6, wherein said tubular structure is molded of a semi-rigid plastic composition.

10. The squeegee handle assembly of claim 6, wherein said stabilizing structure comprises divergent stabilizing fin members fixed to said tubular structure interior.

11. A handle assembly for a squeegee applicator tool having first and second tapered blades and two ribs separating the tapered blades, said handle assembly comprising:
a) a tubular body having an inner wall and first and second externally disposed lips which define an elongated opening, said tubular body constructed of a semi-rigid, elastic material whereby the spreading of said first and second lips to increase the size of said elongated opening causes said tubular body to provide a squeezing force; and
b) a blade stabilizing structure extending from said inner wall of said tubular body and being disposed generally in alignment with said elongated opening, whereby the placement of a tapered blade into the blade stabilizing structure and a rib inside and adjacent the first and second externally disposed lips permits the handle assembly to be used to manipulate a squeegee applicator tool.

12. The handle assembly of claim 11, wherein said tubular body has a length generally coextensive with the length of the squeegee applicator tool.

13. The handle assembly of claim 11, wherein said blade stabilizing structure is generally coextensive with said elongated opening in said tubular body.

14. The handle assembly of claim 11, wherein said blade stabilizing structure is comprised of a pair of divergent fin members extending from said inner wall.

15. The handle assembly of claim 11, wherein a pair of end caps are provided to cover the ends of said tubular body.

16. The handle assembly of claim 11, wherein said first and second lips are in a divergent configuration with respect to each other.

17. The handle assembly of claim 11, wherein said assembly is unitary and molded or extruded of a polymeric material.

18. The handle assembly of claim 11, wherein the distance between said stabilizing structure to said elongated opening is a specified distance to trap a portion of a squeegee applicator therebetween.

19. The handle assembly of claim 11, wherein said first and second lips each extend outward approximately 90° with respect to said tubular body.

20. The handle assembly of claim 14, wherein said tubular body has a diameter and wherein said divergent fin members extend into said tubular body approximately one fourth said diameter.
